(19) United States
(12) Patent Application Publication
(10) Pub. No.: US 2015/0272824 A1
(43) Pub. Date: Oct. 1, 2015

(54) APPARATUSES, SYSTEMS, AND METHODS FOR PRODUCT PACKAGING

(71) Applicant: AESYNT, Cranberry, PA (US)

(72) Inventors: Robert Jaynes, Mars, PA (US); William B. Pattison, Mars, PA (US)

(73) Assignee: AESYNT, Cranberry, PA (US)

(21) Appl. No.: 14/224,718

(22) Filed: Mar. 25, 2014

(51) Int. Cl. A61J 1/03; B65B 61/26; B65B 5/00; B65D 33/00; B65D 85/00

(52) U.S. Cl. CPC A61J 1/03; B65D 33/004; B65D 85/00; B65B 5/00; B65B 61/26; A61J 2205/10; A61J 2205/30

(57) ABSTRACT

Provided herein are various apparatuses, systems, and methods for enclosing or substantially enclosing a product within a package, and more particularly, to enclosing medication in a packaging with at least a portion that can be transitioned between a substantially transparent state and a substantially opaque state. In particular, a medication package is provided that includes an enclosure, a medication disposed within the enclosure, and indicia carried by the enclosure. The enclosure may include a variable transparency material, wherein the material transparency is configured to vary from a substantially transparent state to a substantially opaque state. The indicia may be visible in response to the variable transparency material being in the substantially transparent state and the indicia may not be visible in response to the variable transparency material being in the substantially opaque state.

### TECHNOLOGICAL FIELD

Embodiments of the present invention relate generally to enclosing or substantially enclosing a product within a package, and more particularly, to enclosing medication in a packaging with at least a portion that can be transitioned between a substantially transparent state and a substantially opaque state.

### BACKGROUND

Various types of high-value products may be susceptible to theft and tampering, particularly when those products are readily visible to would-be thieves. For example, the theft of narcotics and high-cost medications can cost hospitals billions of dollars annually. The special handling and storage requirements of some products, such as narcotics and high-cost medications, can present high operating costs to handlers/distributors, such as hospitals, because the narcotics and high-cost medications may not be stocked together with conventional medications, such as in a relatively unsecure automated dispensing device.

Further, labeling requirements may make narcotics and high-cost medications easily identifiable to would-be thieves. Healthcare facilities generally dispense medications from a central pharmacy to patients with a number of verification and handling steps performed along the way to ensure that the correct medication type and dose is delivered to the appropriate patient. The verification steps and handling of the medications may create situations from which medications may inadvertently be made vulnerable or available to thieves. Protecting medications during the verification and handling processes can add complexity and time to the process of medication distribution such that the distribution process becomes less efficient.

### SUMMARY

Embodiments of the present invention may provide various apparatuses, systems, and methods for packaging a product, and more particularly, to enclosing a product in a package with at least a portion of the packaging being capable of transitioning between a substantially transparent state and a substantially opaque state. Embodiments may provide a medication package including an enclosure, a medication disposed within the enclosure, and indicia carried by the enclosure. The enclosure may include a variable transparency material, wherein the material transparency is configured to vary from a substantially transparent state to a substantially opaque state. The indicia may be visible in response to the variable transparency material being in the substantially transparent state and the indicia may not be visible in response to the variable transparency material being in the substantially opaque state. The material may be in a substantially opaque state in response to the material temperature being below a first predefined temperature, and where the material is in a substantially transparent state in response to the material being above a second predetermined temperature. The indicia carried by the enclosure may be a first indicia, the package further comprising second indicia, where the first indicia and the second indicia may be visible in response to the variable transparency material being in the substantially transparent state, where the first indicia is not visible in response to the variable transparency material being disposed in the substantially opaque state, and the second indicia is visible in response to the variable transparency material being disposed in the opaque state. According to some embodiments, the variable transparency material is responsive to at least one of an electrical current, a chemical exposure, or exposure to a predetermined wavelength of light to transition the variable transparency material between the substantially transparent state and the substantially opaque state.

Embodiments of the present invention may provide a package including an enclosure, where at least a portion of the enclosure includes a variable transparency material, where the variable transparency material is configured to vary between a substantially transparent state and a substantially opaque state. The package may include first indicia carried by the package, where the first indicia is visible in response to the variable transparency material being in the substantially transparent state, and where the first indicia is not visible in response to the variable transparency material being in the substantially opaque state. The package may include a near field communication tag, where the near field communication tag may be readable regardless of the material transparency. The package may include second indicia carried by the package, where the second indicia is visible regardless of the material transparency. The first indicia may be disposed on the variable transparency material, and where the first indicia is of a color that blends in with the variable transparency material when the variable transparency material is in the substantially opaque state.

According to some embodiments, the enclosure may define a cavity configured to receive a product therein, where the variable transparency material includes a first side presented on an exterior of the package, and a second side exposed to the cavity of the material, where the first indicia may be disposed on the second side of the variable transparency material. The package may include second indicia where the second indicia may be disposed on the first side of the variable transparency, and the second indicia may be visible regardless of the material transparency. The enclosure may define a cavity configured to receive a product therein, where the variable transparency material includes a first side presented on an exterior of the package and a second side exposed to the cavity of the cavity of the enclosure, where the product is visible through the variable transparency material in response to the variable transparency material being in the substantially transparent state. The material may be in a substantially opaque state in response to the material temperature being below a first predetermined temperature, and the material may be in a substantially transparent state in response to the material temperature being above a second predetermined temperature. The variable transparency material may be responsive to at least one of an electrical current, a chemical exposure, or exposure to a predetermined wavelength of light to transition the variable transparency material between the substantially transparent state and the substantially opaque state.

Embodiments of the present invention may provide a method including forming a package from a variable transparency material, where the material transparency is configured to be varied from a substantially transparent state to a substantially opaque state, and associating first indicia to the variable transparency material, where the first indicia is visible in response to the variable transparency material being in the substantially transparent state, and the first indicia is not visible in response to the variable transparency material being in the substantially opaque state. Methods may include associating a second indicia to the package, where the second indicia is visible regardless of the material transparency. The package may define an enclosed cavity, where the first indicia may be printed to an interior surface of the material facing the enclosed cavity, and the second indicia may be printed to an exterior surface, opposite the surface of the material facing the enclosed cavity.

According to some embodiments, methods may include causing the variable transparency material to transition to the substantially transparent state in response to elevating the temperature of the material above a first predefined temperature, and causing the variable transparency material to transition to a substantially opaque state in response to reducing the temperature of the material below a second predefined temperature. Methods may include causing the variable transparency material to transition between the substantially transparent state and the substantially opaque state in response to at least one of applying an electrical current to the material, exposing the material to a chemical, or exposing the material to a predetermined wavelength of light.

### DESCRIPTION OF THE DRAWINGS

Reference now will be made to the accompanying drawings, which are not necessarily drawn to scale, and wherein:

FIG. 1 illustrates an enclosure comprising a variable transparency material that is in a substantially transparent state according to an example embodiment of the present invention;

FIG. 2 illustrates the enclosure of FIG. 1 with the variable transparency material in a substantially opaque state according to an example embodiment of the present invention;

FIG. 3 illustrates a system for packaging and inspecting a medication in an enclosure comprising a variable transparency material according to an example embodiment of the present invention;

FIG. 4 illustrates an enclosure comprising a variable transparency material that is in a substantially transparent state according to another example embodiment of the present invention; and

FIG. 5 illustrates the enclosure of FIG. 4 with the variable transparency material in a substantially opaque state according to an example embodiment of the present invention.

### DETAILED DESCRIPTION

Embodiments of the present invention may provide various apparatuses, systems, and methods for packaging a product, and more particularly, to enclosing a product in a package with at least a portion of the packaging being capable of transitioning between a substantially transparent state and a substantially opaque state. Some embodiments and components of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements.

While embodiments of the present invention may be described with respect to the packaging of medications, such as narcotics and high-cost medications, within a healthcare environment, embodiments of the inventions described herein may be implemented in other environments, and with other articles and products, such as high-cost, small form-factor products.

Healthcare facilities may include a central pharmacy in which medications are stored and dispensed to areas throughout the healthcare facility. Some healthcare facilities may rely on a supplier, distribution center, or remote central pharmacy which stores medications and supplies at a remote location and delivers the medications and supplies on an as needed basis. In such an embodiment, the medications from the supplier, distribution center, or remote central pharmacy may be received by a healthcare facility at a receiving area. While embodiments of the present invention may be described as transporting and dispensing medication from a central pharmacy, embodiments in which central pharmacies are located remotely or embodiments using distribution centers may implement embodiments of the inventions from the area in which medications and supplies are received from the central pharmacy or distribution center.

The various steps involved in transporting medications from a central pharmacy to a patient may each provide an opportunity for the theft of a high-cost medication or a medication that is commonly abused, such as a narcotic. Further, as medications often require prominent labeling to minimize medication distribution errors, it may be easy for a thief to identify the high-cost medications and narcotics, making them easier targets. As it is impractical for each dose of a high-cost medication to be manually delivered from the central pharmacy to a patient on an individual basis without the medication changing hands, it may be beneficial to provide a medication package which can improve the security and reduce the likelihood of medication theft.

Federal and state regulations exist that require a certain amount of time to elapse before someone can gain access to medication storage. Medication protections can include storage container thickness, container weight, number of locks on the container or on a compartment in which the container is secured, or how the container or compartment is anchored to the surrounding area. However, once these safeguards have been defeated, it may be relatively easy to identify the medications being sought due to prominent labeling of the medications.

Embodiments of the present invention may provide an apparatus, system, and method to package and conceal a product (e.g., high-cost and/or narcotic medications) while making the package easily accessible and identifiable by healthcare staff.

According to an example embodiment of the present invention, a smart packaging material may form an enclosure or a portion of an enclosure. The smart packaging material may be a variable transparency material that is configured to vary from a substantially transparent state to a substantially opaque state with the application of a stimulus or catalyst. Such a material may allow the contents of the enclosure to be visible when the material is in a substantially transparent state, while preventing the contents of the enclosure from being visible when the material is in a substantially opaque state. Further, the enclosure may include indicia thereon, or indicia within the enclosure that may be visible when the material is in a substantially transparent state, and where the indicia is not visible when the material is in a substantially opaque state.

The term “substantially transparent” as used herein is used to refer to a state in which an object and/or indicia are visible through a substantially transparent material. Substantially transparent may include a completely transparent state in which the material is substantially invisible, or a mostly-transparent state, in which the material is not completely transparent, but it is sufficiently transparent that indicia can be read through the material. The term “substantially opaque” as used herein is used to refer to a state in which an object and/or indicia is not visible through a substantially opaque material. Substantially opaque may include a material that does not allow light to permeate at all (i.e., completely opaque), or a material that is translucent, but diffuses light sufficiently such that an object or indicia cannot be identified through the material.

The variable transparency material described herein may be varied between substantially transparent and substantially opaque, and back again. Optionally, according to some embodiments, the material may be varied from substantially transparent to substantially opaque without the ability to become substantially transparent again. Such a material may function similar to a thermally reactive ink, in which upon heating, the ink is activated and darkened, but the ink cannot be reversed by cooling. However, according to a preferred embodiment, the variable transparency material of example embodiments may be transitioned from a substantially transparent state to-and-from a substantially opaque state.

Transitioning the variable transparency material from a substantially transparent state to a substantially opaque state may be performed by various means. For example, a material, such as a thermally clarified plastic, may be heated above a predetermined temperature (e.g., 90 degrees Fahrenheit) to cause the material to become substantially transparent. The same material may be cooled below a predetermined temperature (e.g., 80 degrees Fahrenheit) to cause the material to become substantially opaque. Variable transparency material may also be activated between states with an electrical current. For example, a material may be in a substantially opaque state until an electrical current is applied to the material, at which point the material may transition to a substantially transparent state. Upon removal of the electrical current, the material may revert to the substantially opaque state. Optionally, a material may be in a substantially opaque state until an electrical current is applied, and then transition to a substantially transparent state. The substantially transparent state may be maintained until another electrical current is applied to cause the material to transition to the substantially opaque state. Material may also be transitioned between the substantially opaque state and the substantially transparent state using a chemical change agent. For example, the material may be in a substantially opaque state until a chemical is applied (e.g., sprayed, rubbed, etc.) causing the material to transition to a substantially transparent state. The material may transition back to the substantially opaque state when the chemical is neutralized, such as by the use of another chemical, rinsing of the chemical agent, or drying of the chemical agent. Another example embodiment may include a variable transparency material that is responsive to a particular wavelength of light. For example, a material may be in a substantially opaque state until the application of a light, such as a light of an ultraviolet wavelength, at which point the material may transition to the substantially transparent state where it was exposed to the light. While the aforementioned methods have been described as transitioning to a substantially transparent state in response to a stimulus (e.g., light, chemical, electrical, thermal), embodiments may transition in the opposite manner, transitioning to the substantially opaque state in response to any of the aforementioned stimuli.

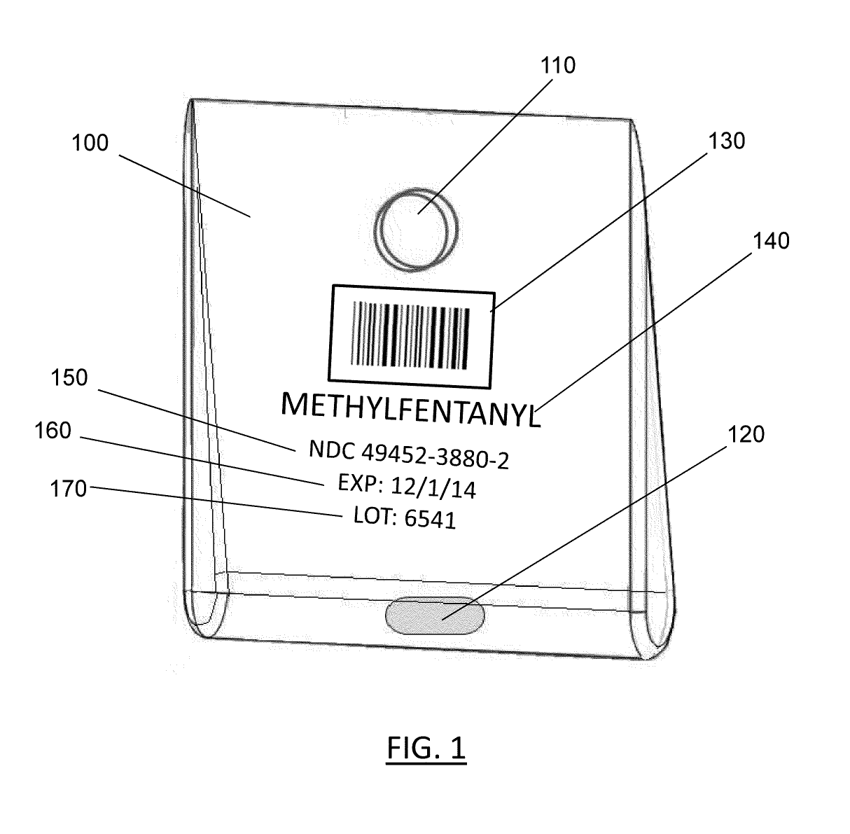

In practice, in a medical facility, a medication may be inspected after packaging by a pharmacist to confirm that the appropriate medication was packaged and labeled properly. A packaged medication is illustrated in FIG. 1 including a packaging enclosure 100 formed of the variable transparency material and a medication unit dose 120 disposed therein. The enclosure 100 of the illustrated embodiment further includes a hole 110 configured to receive there through a rod for hanging the enclosure 100 on. The rod may be a component of a storage system, such as an automated storage system. While the illustrated embodiment is depicted to be an enclosure 100 that may be hung on a rod for storage and subsequent dispensing, it is appreciated that virtually any form factor of enclosure may be implemented according to example embodiments of the present invention, and the embodiment of FIG. 1 is merely illustrative of one example form factor. Further, example embodiments may include multiple medication unit doses carried by the enclosure, such as all of the medications required by a particular patient at a particular time.

The enclosure 100 may include indicia disposed on or within the enclosure. The indicia may include, for example, a barcode 130, a medication name 140, a National Drug Code (NDC) number 150, an expiration date 160, a lot number 170, or any other information which may be useful or required for certain types of products and packaging. As shown, the variable transparency material of the enclosure 100 is in the substantially transparent state with the indicia 130-170 being visible and the medication unit dose 120 also being visible through the material of the enclosure in this state. The medication unit dose 120 may be inserted into the enclosure 100 through an automated packaging machine, for example, where the machine is configured to load the medication unit dose 120 to the enclosure 100 and print the indicia 130-170 on the enclosure. The printing and loading operations may be performed in any order and the automated packaging machine may incorporate various mechanisms for identifying the medication unit dose and properly printing the appropriate indicia to the enclosure.

While the illustrated embodiment of FIG. 1 depicts barcode 130 indicia disposed on the enclosure 100, embodiments may include a near field communication identification tag, such as a radio-frequency identification (RFID) tag disposed in or on the enclosure 100 in addition to or instead of the barcode 130 indicia. The near field communication identification tag may be configured to communicate via any known protocol, including RF, Zigbee™, Bluetooth™, WiFi, etc. The barcode 130 and/or identification tag (not shown) may have information encoded thereto including medication identification information (e.g., medication name, dose, lot number, expiration date, etc.) Further, the barcode 130 and/or identification tag may include an identification of a patient for whom the medication is intended (e.g., patient name or identification number) and/or a destination (e.g., a patient room or a storage location). In either case, the barcode 130 or the identification tag, the information contained therein may not be human-readable and may require a machine to read the information, such as a barcode reader or an identification tag reader, such as an RFID reader. The enclosure also includes human-readable indicia 140-170 to enable a person, such as a pharmacist, to inspect the enclosure 100 and the medication unit dose 120 contained therein to confirm that the medication unit dose 120 matches the indicia 140-170 of the enclosure 100.

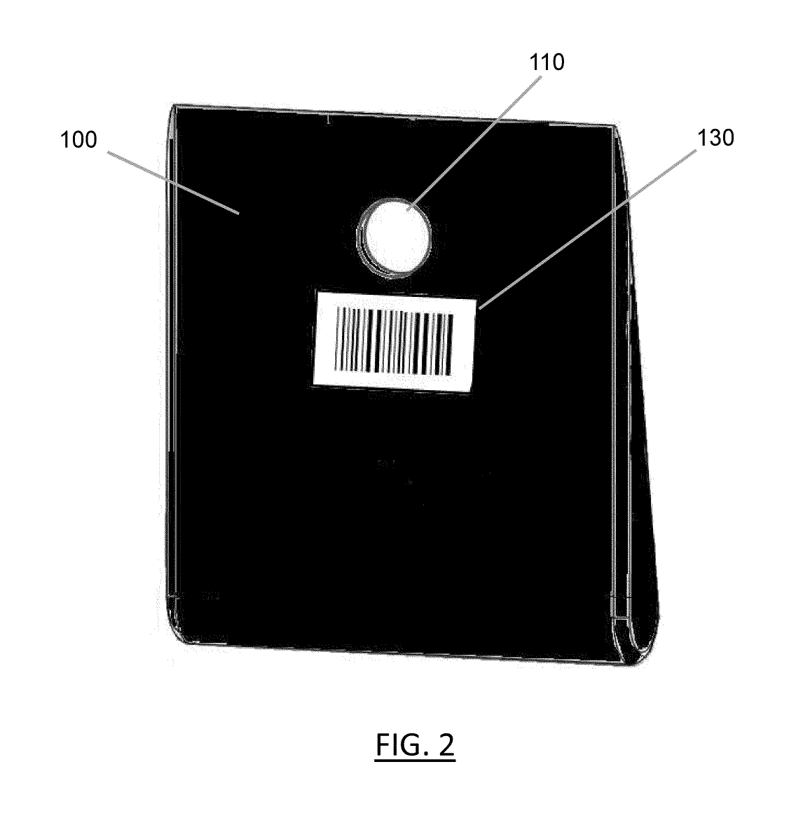

As outlined above, the variable transparency material of the enclosure 100 may be in a substantially transparent state in response to various environmental stimuli, such as thermal, chemical, light, or electrical. In response to the removal of the stimulus (or application of a stimulus in dependence of the material type), the enclosure 100 may transition to a substantially opaque state. FIG. 2 illustrates an example embodiment of the enclosure of FIG. 1 with the variable transparency material transitioned to the substantially opaque state. As shown, the human readable indicia 140-170 may no longer be visible. The human-readable indicia may become unreadable in response to those indicia being printed on the inside of the enclosure such that upon the material becoming substantially opaque, the interior surface of the enclosure is no longer visible. Optionally, the human readable indicia 140-170 may be printed to the enclosure in a color that substantially matches the color of the variable transparency material in the substantially opaque state, rendering the indicia unreadable. In either case, the indicia is still present, but unreadable with the variable transparency material in the substantially opaque state. While some of the indicia, in the instant embodiment, the human readable indicia 140-170, may become unreadable when the material is in the substantially opaque state, some indicia, such as the barcode indicia 130, may remain readable, albeit by a machine. For example, the barcode indicia 130 may be printed over a contrasting background or the enclosure may have an area of contrast disposed thereon that provides a location where indicia can be read in any material state. Optionally, indicia may be printed to the variable transparency material on an exterior surface of the enclosure in a color which may remain visible whether the variable transparency material is in the substantially transparent state or the substantially opaque state. Similarly, an RFID tag would remain readable regardless of the optical transparency state of the material. According to some embodiments, some human readable indicia may remain readable when the material is in the substantially opaque state, such as a patient name. However, indicia providing an indication of the contents of the enclosure 100 in human readable form may be obscured when the material is in the substantially opaque state.

The enclosure 100 of FIGS. 1 and 2 can be used to allow the contents of the enclosure and information about the contents (e.g., indicia 140-170) to be visible when the variable transparency material is in the substantially transparent state of FIG. 1, while the contents and the human readable information about the contents of the enclosure 100 may be obscured and not visible in response to the variable transparency material being in the substantially opaque state. Such an enclosure may be useful in the workflow of a healthcare facility or pharmacy, as described further below.

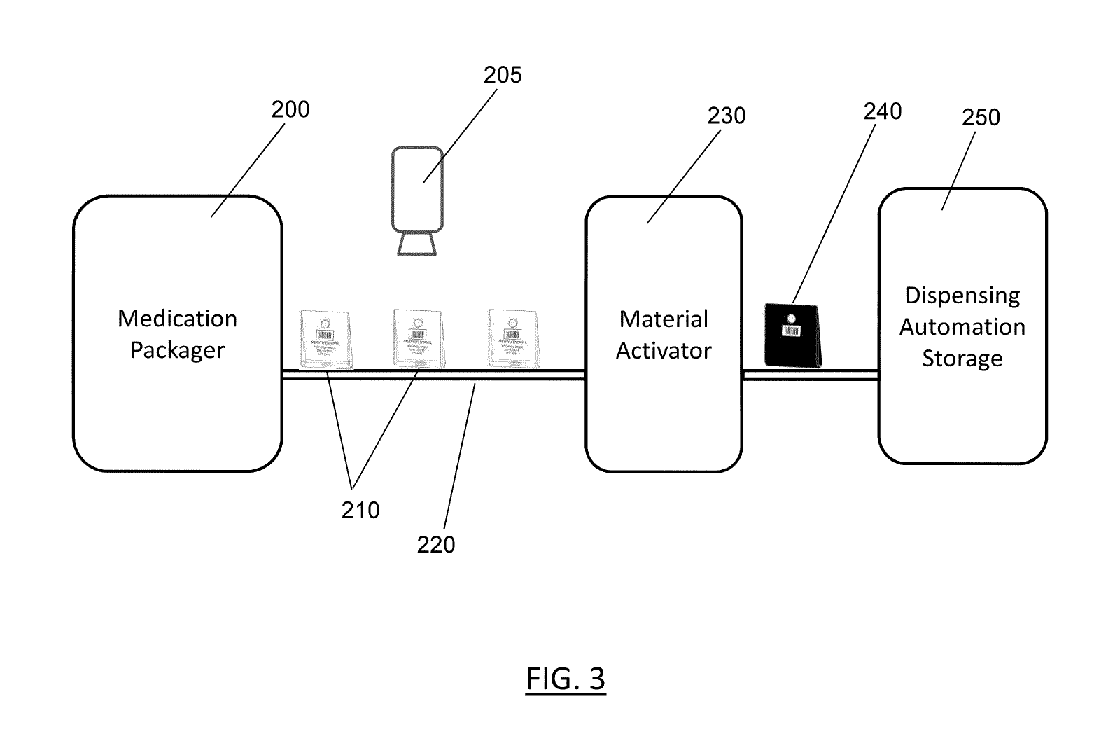

FIG. 3 illustrates an example embodiment of a simplified workflow of a pharmacy operation, where the pharmacy may be within a healthcare facility. A medication packager 200 may be used to package a medication unit dose (or plurality of unit doses) in an enclosure. The medication packager may form the package around the unit dose or the medication packager may simply insert a medication unit dose into an enclosure. The enclosure may be printed to before receiving the medication unit dose or after a unit dose of medication has been received with identifying indicia, such as the indicia described with respect to FIG. 1. Further, the printing may be on a surface that becomes an inner surface of the enclosure when the enclosure is sealed around the medication unit dose. Optionally, the medication packager may print identifying indicia to a separate object, such as a card, to be inserted into the enclosure and readable through the enclosure when the enclosure is in the substantially transparent state. While the illustrated embodiment depicts a medication packaging apparatus, embodiments may include manual packaging operations, such as an operator packaging a medication in a pre-printed package or the like, while not deviating from the scope of the invention.

After the medication is packaged in an enclosure with identifying indicia, the packaged medication may move to an inspection station. The material of the enclosure is in the substantially transparent state at this time. The illustrated embodiment of FIG. 3 depicts a conveyor 220 advancing packaged medications 210 from the medication packager. The inspection station may be a location where a pharmacist is physically present, and/or the inspection station may include an image capture device, such as image capture device 205 of FIG. 3, configured to capture an image of the packaged medication including the identifying indicia and the medication unit dose. In either case, the packaged medication is inspected at the inspection station to verify the contents and identity of the medication unit dose in the enclosure and the identifying indicia disposed thereon. According to some embodiments, the inspection process may be automated using an image capture device and a controller configured to verify the contents and the identifying indicia. Upon passing inspection, the variable transparency material of the packaged medication may be transitioned from a substantially transparent state (as shown in FIG. 1) to a substantially opaque state (as shown in FIG. 2). This may be accomplished by a stimulus either being applied to the material (e.g., thermal, chemical, light, electrical), or the stimulus being removed. In an example embodiment in which a variable transparency material is substantially transparent above 90 degrees Fahrenheit, the inspection operation may occur with the packaged medication in an environment above 90 degrees. Upon exiting the inspection, ambient room temperature of the pharmacy, which may be about 70 degrees Fahrenheit, may cause the variable transparency material to transition to the substantially opaque state. According to the embodiment of FIG. 3, a material activator 230 is illustrated which may apply a stimulus to the variable transparency material to cause the material to transition to the substantially opaque state.

As shown in FIG. 3, upon the packaged medication 240 being transitioned to the substantially opaque state, the packaged medication 240 is ready for storage, transport or dispensing. The packaged medication 240 may be loaded to a medication cart, sent to a nurse station or patient room, or sent to dispensing automation storage device 250 as shown in FIG. 3. While the medication is being transported, dispensed, or stored, the type of medication is masked by the substantially opaque enclosure. However, the enclosure may still be read by a barcode scanner or a reader, such as an RFID tag reader, to determine the identity of the medication in the enclosure. In this manner, the medication is camouflaged and indiscernible from other medication types.

According to some embodiments, an authorized healthcare employee may be able to cause the variable transparency material to be transitioned to the substantially transparent state at a location remote from the system of FIG. 3. For example, a packaged medication may be transported to a patient bedside or room via automated, partially automated, or manual transportation. Upon arrival, prior to opening the packaged medication 240 to remove the medication, an authorized healthcare person may cause the variable transparency material to be transitioned to the substantially transparent state by, for example, heating the package, exposing the package to a particular wavelength of light, applying a chemical to the package, or applying an electrical current to the package. The apparatus used to apply any of the heat, light, chemical, or electrical stimulus may be stationary, such as a fixed apparatus in a room, or a portable apparatus, such as carried by the authorized healthcare person or attached to a nurse cart. The apparatus to apply the stimulus may require authorization to be used in order to provide an added level of security to the opacity of the packaged medication.

While an authorized healthcare person may cause a packaged medication to transition to a substantially transparent state for viewing/confirming the contents of the medication package, according to some embodiments, the authorized healthcare person may not have an immediate need for the packaged medication, or be distracted by a more pressing engagement. According to embodiments of the present invention, a medication package, while left unattended, may be transitioned to the substantially opaque state. Said differently, the mechanisms to transition between a substantially transparent state and a substantially opaque state may be configured such that a medication package left at a standard temperature (e.g. between about 60 and about 85 degrees Fahrenheit) without exposure to a particular wavelength of light, chemical, or electrical current, may transition to, or remain in, the substantially opaque state. Such a configuration where the substantially opaque state is the “default” package state may provide an added level of security to the packaging of example embodiments as a positive application of a stimulus would be required to view the medication or indicia identifying the medication of a package.

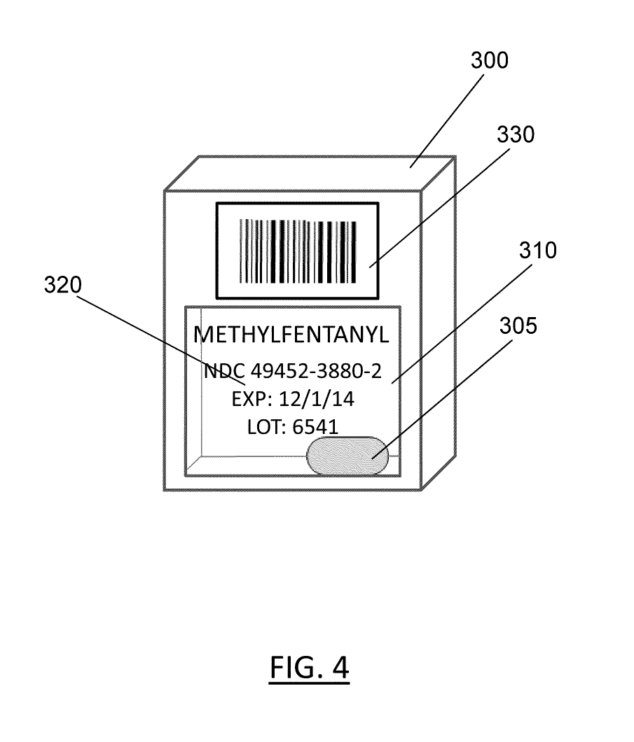

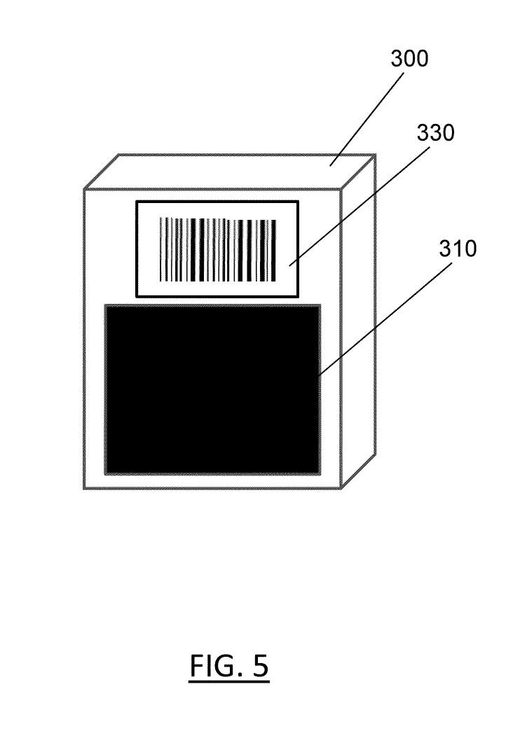

FIG. 4 illustrates another example embodiment of an enclosure according to the present invention. As shown, only a portion 310 of the enclosure 300 comprises a variable transparency material with human readable indicia 320 disposed thereon and a medication unit dose 305 visible there through. FIG. 5 illustrates the enclosure 300 of FIG. 4 with the variable transparency material transitioned to the substantially opaque state, wherein the human readable indicia 320 of FIG. 4 is no longer readable, and the contents of the enclosure are no longer visible.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A medication package comprising:
an enclosure;
a medication disposed within the enclosure; and
indicia carried by the enclosure;
wherein the enclosure comprises a variable transparency material, wherein the material transparency is configured to vary from a substantially transparent state to a substantially opaque state, wherein contents of the enclosure are visible in response to the material being in the substantially transparent state, and not visible when the material is in the substantially opaque state.

2. The medication package of claim 1, wherein the indicia is visible in response to the variable transparency material being in the substantially transparent state, and wherein the indicia is not visible in response to the variable transparency material being in the substantially opaque state.

3. The medication package of claim 1, wherein the material is in a substantially opaque state in response to the material temperature being below a first predetermined temperature, and wherein the material is in a substantially transparent state in response to the material temperature being above a second predetermined temperature.

4. The medication package of claim 1, wherein the indicia carried by the enclosure is a first indicia, the package further comprising second indicia, wherein the first indicia and the second indicia are visible in response to the variable transparency material being in the substantially transparent state, wherein the first indicia is not visible in response to the variable transparency material being disposed in the substantially opaque state, and wherein the second indicia is visible in response to the variable transparency material being disposed in the substantially opaque state.

5. The medication package of claim 1, wherein the variable transparency material is responsive to at least one of an electrical current, a chemical exposure or exposure to a predetermined wavelength of light to transition the variable transparency material between the substantially transparent state and the substantially opaque state.

6. A package comprising:
an enclosure, wherein at least a portion of the enclosure comprises a variable transparency material, wherein the material transparency is configured to vary between a substantially transparent state and a substantially opaque state; and
first indicia carried by the package, wherein the first indicia is visible in response to the variable transparency material being in the substantially transparent state, and wherein the first indicia is not visible in response to the variable transparency material being in the substantially opaque state,
wherein contents of the enclosure are visible in response to the material being in the substantially transparent state, and not visible when the material is in the substantially opaque state.

7. The package of claim 6, further comprising a near field communication tag, wherein the near field communication tag is readable regardless of the material transparency.

8. The package of claim 6, further comprising second indicia carried by the package, wherein the second indicia is visible regardless of the material transparency.

9. The package of claim 6, wherein the first indicia is disposed on the variable transparency material, and wherein the first indicia is of a color that blends in with the variable transparency material when the variable transparency material is in the substantially opaque state.

10. The package of claim 6, wherein the enclosure defines a cavity configured to receive a product therein, wherein the variable transparency material comprises a first side presented on an exterior of the package, and a second side exposed to the cavity of the material, wherein the first indicia is disposed on the second side of the variable transparency material.

11. The package of claim 10, further comprising second indicia, wherein the second indicia is disposed on the first side of the variable transparency material, and wherein the second indicia is visible regardless of the material transparency.

12. The package of claim 6, wherein the enclosure defines a cavity configured to receive a product therein, wherein the variable transparency material comprises a first side presented on an exterior of the package, and a second side exposed to the cavity of the enclosure, wherein the product is visible through the variable transparency material in response to the variable transparency material being in the substantially transparent state.

13. The package of claim 6, wherein the material is in a substantially opaque state in response to the material temperature being below a first predetermined temperature, and wherein the material is in a substantially transparent state in response to the material temperature being above a second predetermined temperature.

14. The package of claim 6, wherein the variable transparency material is responsive to at least one of an electrical current, a chemical exposure or exposure to a predetermined wavelength of light to transition the variable transparency material between the substantially transparent state and the substantially opaque state.

15. A method comprising:
forming a package from a variable transparency material, wherein the material transparency is configured to vary from a substantially transparent state to a substantially opaque state; and
associating first indicia to the variable transparency material, wherein the first indicia is visible in response to the variable transparency material being in the substantially transparent state, and wherein the first indicia is not visible in response to the variable transparency material being in the substantially opaque state,
wherein contents of the package are visible in response to the material being in the substantially transparent state, and not visible when the material is in the substantially opaque state.

16. The method of claim 15, further comprising:
associating second indicia to the package, wherein the second indicia is visible regardless of the material transparency.

17. The method of claim 16, wherein the package defines an enclosed cavity, wherein the first indicia is printed to an interior surface of the material facing the enclosed cavity, and wherein the second indicia is printed to an exterior surface, opposite the surface of the material facing the enclosed cavity.

18. The method of claim 15, further comprising:
causing the variable transparency material to transition to the substantially transparent state in response to elevating the temperature of the material above a first predefined temperature; and
causing the variable transparency material to transition to a substantially opaque state in response to reducing the temperature of the material below a second predefined temperature.

19. The method of claim 15, further comprising:
causing the variable transparency material to transition between the substantially transparent state and the substantially opaque state in response to at least one of applying an electrical current to the material, exposing the material to a chemical, or exposing the material to a predetermined wavelength of light.
